(19) United States
(12) Patent Application Publication
(10) Pub. No.: US 2014/0356508 A1
(43) Pub. Date: Dec. 4, 2014

(54) HIGHLY THICKENING PASTE COMPOSITION AND METHOD FOR PRODUCING SAME, AND LOW-VISCOSITY SUBSTANCE AND METHOD FOR CONTROLLING VISCOSITY THEREOF BOTH USING SAME

(71) Applicant: SOMAR CORPORATION, Tokyo (JP)

(72) Inventors: Yoshihiro Ueda, Tokyo (JP); Takunori Matsumoto, Tokyo (JP)

(21) Appl. No.: 14/372,479

(22) PCT Filed: Jan. 18, 2013
(86) PCT No.: PCT/JP2013/051007

§ 371 Date: Jul. 16, 2014

(30) Foreign Application Priority Data
Jan. 19, 2012 (JP) 2012-009497

(51) Int. Cl. A23L 1/0526; A23L 1/054

(52) U.S. Cl. CPC A23L 1/0526; A23L 1/0541; A23V 2002/00
USPC 426/573

(57) ABSTRACT

Provided is a highly thickening composition which overcomes drawbacks seen in thickening compositions using a polysaccharide in that a desired viscosity cannot be achieved when the thickening composition is added to a liquid composition having a specific salt concentration, and that even when the desired viscosity is achieved, the resultant liquid composition shows deterioration of texture such as remaining in the mouth or being hard to swallow because the resultant liquid composition undergoes little change in viscosity at respective temperatures, and which has a synergistically excellent thickening property. A highly thickening composition produced by mixing one of either (A) xanthan gum or (B) locust bean gum with (C) guar gum and then mixing the component (A) or the component (B) to the resultant mixture, wherein the ratio of the total amount of the components (A) and (B) to the amount of the component (C) is 95:5 to 70:30 by mass and the component (A) is contained in a larger amount than the component (B).

### TECHNICAL FIELD

The present invention relates to a highly thickening composition which enables, by adding the same to an aqueous low-viscosity substance, to impart high-viscosity to the substance, to make the substance gel, or to control the viscosity of the substance. Particularly, it relates to a highly thickening composition which enables to lower the viscoelasticity of the substance at a specific temperature, when compared to that of the conventional thickening compositions, and a method of producing the same, as well as a low-viscosity substance using the same and a method of controlling the viscosity of the substance.

### BACKGROUND ART

In the field of the food or cosmetic industry, thickening compositions are used to improve the viscosity of low-viscosity substances or carry out gelation. For example, gelatin is often contained in many foods such as general jelly for the purpose of a gelling or thickening effect and a melt-in-mouth effect around 15° C. to 25° C. However, since gelatin is a material obtained from animal proteins, it not only has many problems such as allergy, but also, due to its irreversibility by temperature change, has many issues in methods for producing products and on storage. Further, content of gelatin in foods must be, in general, from a few percent to 10 percent to facilitate gelling or thickening effect, leading to a large loading of gelatin and off-flavor, which results in degradation in product's value or discomfort.

To solve these problems, trials for using thickening compositions comprising polysaccharide have been carried out. Such thickening compositions which have been proposed as a stabilizer for producing frozen dessert include a combination of 10 to 30% by mass of xanthomonas gum, 10 to 30% by mass of locust bean gum and 40 to 80% by mass of guar gum (see, Patent Document 1).

In addition, for thickening and prevention of viscosity reduction of various additive-containing cooked foods (e.g. curries such as beef curry, chicken curry, hashed beef and curried rice, as well as beef bowl, chicken kamameshi, fried rice, rice fried with chicken, pan-fried noodle), and for maintenance of uniformly mixed state between solid phase (e.g. meat or vegetable) and oil phase (e.g. lard or salad oil), and for prevention of texture reduction (e.g. pasty feeling), xanthan gum or materials for additive-containing cooked food in which xanthan gum and one or more of locust bean gum and/or guar gum and/or tara gum and/or karaya gum and/or pectin and/or red alga extract are combined have also been proposed (see, Patent Document 2).

Further, a gelation composition comprising xanthan and guar gum, depolymerized galactomannan and at least one kind of polysaccharide selected from combination thereof, and further locust bean gum has been proposed (see, Patent Document 3). Also, a thickening stabilizer containing water dispersible cellulose for improving a drawback such as poor liquid separation and occurrence of pasty feeling or sticky feeling when the composition is added to food as observed when at least one kind of polysaccharide selected from galactomannan, xanthan gum, tamarind seed gum, pectin, carrageenan, gellan gum, agar, soybean soluble polysaccharide, glucomannan, sodium alginate, and karaya gum is used as thickening agent has been proposed (see, Patent Document 4).

In Patent Documents 1-3 described above, thickening compositions are shown as examples wherein a compounding ratio by mass of xanthan gum, locust bean gum and guar gum is 10-30:10-30:80-40 in Patent Document 1; wherein the ratio is 2:1:1 in Patent Document 2; and wherein the ratio is 20-80:<20:80-20 in Patent Document 3. Also, in Patent Document 4, a comparative example of a composition wherein guar gum and xanthan gum are mixed at a mass ratio of 3:1 is shown as an example of those which have a drawback such as poor liquid separation, and occurrence of pasty feeling or sticky feeling when the composition is added to food.

### RELATED ART DOCUMENTS

### Patent Documents

Patent Document 1: Japanese Unexamined Patent Application Publication No. S55-102360

Patent Document 2: Japanese Unexamined Patent Application Publication No. S52-136932

Patent Document 3: Japanese Unexamined Patent Application Publication No. H06-279749

Patent Document 4: Japanese Unexamined Patent Application Publication No. 2008-50376

### SUMMARY OF THE INVENTION

### Problems to be Solved by the Invention

As shown in Patent Documents 1-4, thickening agents produced by combining xanthan gum and guar gum are known. These thickening agents, however, have drawbacks such as substantially no change in the effect for increasing viscosity compared to xanthan gum alone and as described above, poor liquid separation, and occurrence of pasty feeling or sticky feeling when the thickening agent is added to food, thereby deteriorating the food quality. In order to overcome these issues, further combinations with locust bean gum have been carried out. In that case, however, though the effect for increasing viscosity was shown, the results were not yet satisfactory in terms of smooth feeling to the throat as well as in-mouth meltability and swallowability that is similar to gelatin, or the like depending on the temperature or salt concentration of a subject to which the thickening agent was used.

Thus, the purpose of the present invention is to provide a highly thickening composition and a production process thereof, which composition sufficiently exhibits thickening effect and lowers the viscosity at a specific temperature even in the presence of NaCl. Thus, the thickening composition of the present invention can overcome the drawbacks seen in the conventional thickening agents when the agents are added to food such as difficulty in swallowing or feeling of sticking in the throat; can solve various problems caused by gelatin while maintaining desirable properties of gelatin; and can exhibit a synergistically excellent thickening property.

The other purpose of the present invention is also to provide a low-viscosity substance using the highly thickening composition and a method of controlling the viscosity thereof.

### Means for Solving the Problems

The present inventors intensively studied for overcoming the drawbacks in a highly thickening composition comprising as an effective ingredient a combination of non-allergic xanthan gum, guar gum and locust bean gum (for example, marked loss of flavor or the like attributed to the loadings and inability to obtain in-mouth meltability like gelatin) and for developing a novel highly thickening composition which shows synergistic effect. As a result, the present inventors discovered in the highly thickening composition that, by adjusting the compounding order and compounding ratio of components into a certain range, high thickening effect is obtained which is accompanied with the use of a conventional thickening composition comprising xanthan gum and locust bean gum or the use of a thickening composition whose compounding ratio of guar gum is more than the others; that the deterioration in the texture such as difficulty in swallowing or feeling of sticking in the throat when the composition is added to food is suppressed; and that the composition exhibits marked increase of thickening property, but changes its viscosity at a specific temperature to increase the in-mouth meltability. Thereby the inventors have completed the present invention based on this discovery.

That is, the thickening composition of the present invention is a highly thickening composition produced by mixing one of either (A) xanthan gum or (B) locust bean gum with (C) guar gum and then mixing the component (A) or the component (B) to the resultant mixture, wherein that the ratio of the total amount of the components (A) and (B) to the amount of the component (C) is 95:5 to 70:30 by mass and the component (A) is contained in a larger amount than the component (B).

In the thickening composition of the present invention, it is preferred that the component (B) and the component (C) are mixed and then the component (A) is mixed with the resultant mixture.

A method of producing a highly thickening composition of the present invention is a method comprising mixing one of either (A) xanthan gum or (B) locust bean gum with (C) guar gum so that the compounding ratio of the component (C) ranges from 5 to 30% by mass of the overall highly thickening composition and then mixing the remaining component (A) or the component (B) to the resultant mixture, wherein the compounding ratio of the component (A) is more than that of the component (B).

Further, a low-viscosity substance of the present invention is characterized in that the highly thickening composition is added thereto.

Further, a method of controlling viscosity of the low-viscosity substance of the present invention is characterized in that the salt concentration of the low-viscosity substance is adjusted to 0.01% or more and the-temperature is maintained in the range between 25° C. and 35° C.

### Effect of the Invention

According to the present invention, the highly thickening composition is provided. It can exhibit sufficient thickening effect even in the presence of NaCl, and moreover, when the composition is added to food, it can overcome the drawbacks seen in the conventional thickening agents such as difficulty in swallowing or feeling of sticking in the throat by lowering the viscosity at a specific temperature. From these result, the highly thickening composition of the present invention can solve various problems caused by gelatin while maintaining desirable properties of gelatin, and exhibit a synergistically excellent thickening property.

### MODE FOR CARRYING OUT THE INVENTION

For the highly thickening composition of the present invention, by selecting the composition and the compounding ratio, the viscosity at 20° C. or higher can be lower compared to when using a conventional thickening composition comprising xanthan gum and locust bean gum, or a thickening composition which contains more guar gum than the others. In particular, the test fluid prepared by dissolving 0.5 g of the composition into 100 g of the aqueous solution containing 0.8% salt concentration at 75° C., stirring for 60 minutes and then cooling the resultant mixture to 30° C. can advantageously change the viscosity at the temperature between 25° C. and 30° C. into 0.9 mPa·s or higher and further change the viscosity at the temperature between 31° C. and 35° C. into 0.6 mPa·s or lower as measured by Type B viscometer (manufactured by TOKYO KEIKI INC., rotational speed : 30 rpm, using No. 4 rotor).

In general, the thickening effect on the low-viscosity substance depends on the amount of added thickening agent. However conventional gelatin or a thickening composition comprising as an effective ingredient polysaccharide need to be compounded so that its ratio is 3-10% by mass or more to give high viscosity. Such a product that is thickened by compounding the thickening composition in such a large amount has problems that occurrence of discomfort caused by off-taste and off-flavor originated from polysaccharide is inevitable.

Since the highly thickening composition of the present invention can prepare products in high viscosity and give desired high viscosity with lower loadings, it can solve such problems.

Xanthan gum used as a component (A) in the present invention is a water-soluble natural polysaccharide obtained through the fermentation of starch such as corn by bacteria, and is a substance having a structure wherein the main chain to which D-glucose is bound through β-1,4 linkage is bound at its anhydroglucose to side chains comprising D-mannose and D-glucuronic acid. Xanthan gums having molecular weight between about 2 million and about 50 million are known, and any of them can be used in the present invention.

Next, locust bean gum used as a component (B) is a polysaccharide obtained by separating and crushing endosperm of beans of carob mainly inhabiting the Mediterranean region and comprises as a major component galactose and mannose.

Guar gum used as a component (C) is a mucoid substance which is contained in endosperm part of seeds of legume guar, and comprises as a major component galactomannan in which galactose and mannose are bound together in the ratio of about 1:2.

The highly thickening composition of the present invention can be obtained by premixing the component (A) and the component (C) and then mixing the component (B), or by premixing the component (C) and the component (B) and then mixing the component (A). In this case, for the compounding ratio of the (A) xanthan gum, (B) locust bean gum and (C) guar gum, the mass ratio of the total amount of the component (A) and the component (B) to the component (C) ranges 95:5-70:30. When the content of the component (C) is more than the range, the viscosity of the low-viscosity substance can hardly be raised, and when the content of component (C) is lower than the range, the ability to control viscosity at a specific temperature will be lost, both of which are not preferred. In addition, in the compounding ratio of the component (A) and the component (B), the component (A) compounded must be more then the component (B). When the component (A) and the component (B) are in the same amount or when the component (B) is more than the component (A), type B viscosity can not reach 10,000 mPa (6 rpm) or more even if, for example, 0.5% by mass of the thickening composition is added to the low-viscosity substance. This indicates that a large amount of the thickening composition is needed to achieve a desired viscosity, which is undesirable because increasing the content of the thickening composition leads to changes in the taste or smell of the low-viscosity substance.

From the viewpoint of the impartment of high viscosity to the low-viscosity substance with lower loadings, the ability to control viscosity at a specific temperature, and the ability to prevent alteration in taste, smell or the like of the low-viscosity substance when the thickening composition is added, preferred compounding ratio of the total amount of the component (A) and component (B) to the component (C) is 93:7-75:25, and more preferably 90:10-80:20, and in the total amount of the component (A) and (B), the compounding ratio of the component (A) preferably must be more than that of the component (B), wherein the compounding ratio of the component (A) ranges 51-80% by mass, and more preferable 52-70% by mass.

By mixing at a particularly preferred range of ratio, the thickening composition can be adjusted which gives a high thickening property and further can obtain a characteristic that, under the salt concentration of 0.01% or more, and at a specific temperature, for example at 25 to 35° C., it can lower the viscosity of the low-viscosity substance by 30% or more than the viscosity at other temperature ranges (ability to control viscosity).

As the highly thickening composition of the present invention, the usage is desirably as low as possible to enable impartment of a high viscosity, for example, viscosity of 10,000 mPa·s or more to a low-viscosity substance. In order to produce the composition, the component (A), the component (B) and the component (C) are advantageously compounded by appropriately selecting the compounding ratio from the above-described compounding ratios so that when a test solution is prepared by dissolving 0.5 g of sample into 100 g of ion exchanged water at a temperature of 75° C. and mixing them for 60 minutes, the viscosity measured by type B viscometer after 24 hours is 10000 mPa·s (6 rpm) or more. In particular, when the viscosity is lowered at a specific temperature, it is preferred to premix one of either the component (A) or component (B) with the component (C), and then mix the remaining component.

The low-viscosity substances which can be thickened by the highly thickening composition of the present invention are not restricted and may be one assuming the form of liquid or paste at room temperature. Such low-viscosity substances include liquid food, liquid cosmetics, liquid pharmaceuticals, liquid industrial products.

Among these, examples of the liquid food include beverages such as coffee, black tea, green tea, cocoa, shiruko, juice, soybean milk, raw milk, processed milk, lactic acid bacteria beverage, calcium enriched beverage, and beverage containing dietary fiber; dairy products such as coffee whitener, whipping cream, pastry cream, soft ice cream; liquid dishes or flavoring agent such as soup, stew, sauce, mop sauce, dressing, mustard, wasabi paste; processed pulp products such as fruit sauce, fruit preparation; fluid diets; gelatinous foods such as jelly or pudding; liquid or paste supplements; and liquid or paste pet foods.

Examples of the liquid phamaceuticals include oral preparations, transnasal preparations, intravenous preparations, intubational preparations, ointments, medicated cosmetics, vitamin preparations, medicated hair restorers, medicated dentifrices, bath preparations, anthelmintics, anti-osmidrosis, mouth fresheners, biomaterials, patch preparations, and skin embrocations.

Examples of the liquid cosmetics include skin care products (such as lotions, milky lotions, liquid foundations, facial treatment masks, moisture creams, facial massage creams, cold creams, cleansing creams, facial cleansers, vanishing creams, emollient creams, hand creams, antiperspirant and deodorants, or sunscreen cosmetics), makeup products (such as foundations, powders, lipsticks, lip balms, blushers, sunscreen cosmetics, pencils, cosmetics for eyelash such as mascaras, manicures or nail polish removers), hair cosmetics (such as shampoos, hair rinses, hair tonics, hair treatment products, pomades, hair chicks, hair creams, hair balms, hair preparations, hair styling products, hair sprays, hair coloring preparations, hair restorers or hair growth stimulants), the other cleaners such as hand cleaning preparations, bath products, shaving preparations, aromatics, dentifrices, ointments, and patch preparations.

Examples of the liquid industrial products include pigments, paints, inks, odor eliminating or aromatic agent, antibacterial or antifungal agents, adhesives, coating agents, sealing agents, heat dissipation agents, various oils (such as cutting oils, or lubricants), puncture repair agents, tyres, tubes for bicycle or automobile, surfactants (dispersants), sanitary supplies, moisture building materials, moisture absorbing materials, absorbing materials, surface protective agents, materials for culture, detergents, liquid soap, and various batteries.

Next, in order to thicken a low-viscosity substance and control its viscosity according to the present invention, the highly thickening composition of the present invention is added to the low-viscosity substance at an amount required for obtaining a desired viscosity, stirred well with heating, and then dispersed uniformly.

During this step, the amount to be added is appropriately selected for the low-viscosity substance depending on how much increase in viscosity is needed. The amount to be added is selected generally from 10% by mass or lower, and preferably from 5% by mass or lower to prevent the impairment of the quality of the product by the addition. For example, the amount to be added is selected from the range of 0.1 to 1% by mass to impart similar viscosity as honey (about 1000 mPa·s in type B viscosity (6 rpm)), and is selected from the range of 0.5 to 10% by mass to impart a elasticity of about 40 Pa or more (5° C.).

Heating temperature to be used is a range of 60 to 90° C., and preferably 80 to 85° C. The viscosity is lowered once by this heating, but is remarkably increased when the mixture is cooled to room temperature, for example 30° C. or lower. Although an excellent improvement in viscosity is observed only by mixing at room temperature compared to when using the conventional thickening composition, a further remarkable thickening effect is acted when the mixture is once heated to 80° C. or higher, and then cooled again.

As a procedure of controlling the viscosity according to the method of the present invention, premixed one of either component (A) or component (B) and component (C) may be mixed, and then added to a low-viscosity substance, after which the remaining component (A) or component (B) may be added to the resultant mixture, or alternatively, one of either component (A) or component (B) may be mixed with component (C), and then mixed with the remaining component (A) or component (B), after which the resultant mixture may be added to a low-viscosity substance. In the present invention, it is particularly advantageous that the thickening composition obtained via a method in which the component (C) and one of the other components are mixed and then mixed with another component is produced, after which the composition is dissolved into water and then added to a low-viscosity substance at once.

The highly thickening composition of the present invention, regardless of using polysaccharide, can give a remarkably high viscosity to a low-viscosity substance. Thus, for example, a thickened substance having a viscosity of 10000 mPa·s or more (type B viscosity, 6 rpm) is obtained with same usage as the conventional thickening composition.

Also, since the highly thickening composition of the present invention can control the viscosity at a specific temperature range, the composition makes it possible to change the texture such as in-mouth meltability and smooth feeling to the throat, and exerts effects such as improvement of safety or handling of foods, medical supplies or the like.

In addition, since the highly thickening composition of the present invention can be transformed at a specific temperature, the composition exerts excellent effects such as making it possible to seal a case tightly with a cover at a normal use temperature when used as sealing agent or adhesive for various batteries (e.g. including lithium-ion battery), car battery or the like, or to lower the viscosity by keeping the composition at a specific temperature during recycle, repair or the like to separate the cover from the case.

These effects are the same as with other industrial low-viscosity substance. For example, in paints, inks, odor eliminating or aromatic agents, antibacterial or antifungal agents, adhesives or the like, it is expected that the transportability or operatability is improved by transforming those which are generally in a solid state into a liquid state when using them or that their performance is improved because they can contain more effective ingredient than ever before.

Further, in order to achieve the viscosity required for the conventional thickening composition, the usage of the highly thickening composition of the present invention can be less than that of the conventional thickening composition, which can sustain off-taste and off-flavor originated from polysaccharide. Thus, in the field of foods or pharmaceuticals for example, the highly thickening composition of the present invention exerts excellent effect that it does not interfere with taste.

In addition, according to the present invention, since high viscosity can be obtained with small usage of the composition, it enables, for example, to increase the amount of the component in a low-viscosity substance, or to add other components, which results in exerting effects of saving resource by reduction of the total amount of product and the like, as well as making the product highly functional. According to the method of the present invention, higher thickening effect can be obtained by heating once and then cooling, the method is preferably used in food field such as particularly jelly or pudding which is heated during manufacturing process.

### EXAMPLES

The present invention will now be described based on Examples and Comparative Examples thereof However, the present invention is not restricted to these examples.

Type B Viscosity (mPa·s)

The type B viscosities of the resulting samples were measured. In measurement of the type B viscosity, type B viscometer (manufactured by TOKYO KEIKI INC., measurement was carried out using No. 4 or No. 3 rotor, at rotational speed of 60 rpm, 6 rpm, for 1 minute) was used to carry out measurement at two point of 25° C. and 35° C. The decrease ratio of the viscosity at 35° C. was measured relative to at 25° C.

### Example 1

Into AIBOI wide-mouthed bottle (250 ml), (B) 40 g of locust bean gum and (C) 10 g of guar gum were added and mixed by manual shaking for 5 minutes, followed by addition of (A) 50 g of xanthan gum into the resulting mixture and further mixture for 5 minutes to obtain a thickening composition. The thickening composition was dissolved into 100 ml of distilled water heated to 75° C. to a concentration of 0.5% by mass, and the resulting mixture was stirred at 1000 rpm for 60 minutes and then cooled naturally to 25° C. to prepare samples. After 24 hours, the temperature of each of the thus obtained samples was adjusted to 25° C. in a water bath, and the type B viscosity was measured. The temperature of the water bath was then raised to 35° C. and kept for 1 hour, followed by measurement of the type B viscosity again. The thus obtained type B viscosities of the samples (60 rpm) are shown in Table 1, and the type B viscosities (6 rpm) are shown in Table 3.

### Example 2

Into AIBOI wide-mouthed bottle (250 ml), (A) 50 g of xanthan gum and (C) 10 g of guar gum were added and mixed by manual shaking for 5 minutes, followed by addition of (B) 40 g of locust bean gum into the resulting mixture and further mixture for 5 minutes to obtain a thickening composition. The thickening composition was dissolved into 100 ml of aqueous solution containing 0.8% salt heated to 75° C. to a concentration of 0.5% by mass, and the resulting mixture was stirred at 1000 rpm for 60 minutes and then cooled naturally to 25° C. to prepare samples. After 24 hours, the temperature of each of the thus obtained samples was adjusted to 25° C. in a water bath, and the type B viscosity was measured. The temperature of the water bath was then raised to 35° C. and kept for 1 hour, followed by measurement of the type B viscosity again. The thus obtained type B viscosities of the samples (60 rpm) are shown in Table 1, and the type B viscosities (6 rpm) are shown in Table 3.

### Example 3

A thickening composition was prepared in the same manner as in Example 1 except that (A) 50 g of xanthan gum and (C) 10 g of guar gum were added into AIBOI wide-mouthed bottle (250 ml) and mixed by manual shaking for 5 minutes, followed by addition of (B) 40 g of locust bean gum into the resulting mixture and further mixture for 5 minutes, and then samples were obtained. The type B viscosities of the thus obtained samples were measured in the same manner as in Example 1. The type B viscosities (60 rpm) are shown in Table 1, and the type B viscosities (6 rpm) are shown in Table 3.

### Elastic Modulus (Pa) and Slope of Loss Tangent (tan δ)

Viscoelasticity (Pa) and slope of loss tangent (tan δ) of the samples prepared in Examples and Comparative Examples were measured by using rheometer (trademark: Kinexus pro Rotary Rheometer manufactured by Malvern Instruments Ltd.) at frequencies of 1 Hz in temperature range varying from 60 to 5° C. (varying continuously by 1° C. per min)

### Example 4

Into AIBOI wide-mouthed bottle (250 ml), (B) 16 g of locust bean gum and (C) 20 g of guar gum were added and mixed by manual shaking for 5 minutes, followed by addition of (A) 64 g of xanthan gum into the resulting mixture and further mixture for 5 minutes to obtain a thickening composition. The thickening composition was dissolved into 100 ml of distilled water heated to 85° C. to a concentration of 0.5% by mass, and the resulting mixture was stirred at 1000 rpm for 60 minutes and then cooled naturally to 60° C. to prepare samples. Elastic modulus (Pa) and the slope of loss tangent (tan δ) of the samples were measured. Elastic modulus and loss tangent at 10° C. of the thus obtained samples are shown in Table 6, and elastic modulus (Pa) at 10° C. and 20° C. are shown in Table 7.

### Example 5

A thickening composition was prepared in the same manner as in Example 4 except that (A) 64 g of xanthan gum and (C) 20 g of guar gum were added into AIBOI wide-mouthed bottle (250 ml) and mixed by manual shaking for 5 minutes, followed by addition of (B) 16 g of locust bean gum into the resulting mixture and further mixture for 5 minutes, and then samples were obtained. Elastic modulus (Pa) and the slope of loss tangent (tan δ) at 10° C. of the thus obtained samples were measured in the same manner as in Example 4. The results were shown in Table 6.

### Comparative Example 1

Into AIBOI wide-mouthed bottle (250 ml), (A) 50 g of xanthan gum and (B) 40 g of locust bean gum were added and mixed by manual shaking for 5 minutes, followed by addition of (C) 10 g of guar gum into the resulting mixture and further mixture for 5 minutes to obtain a thickening composition. The thickening composition was dissolved into 100 ml of distilled water heated to 75° C. to a concentration of 0.5% by mass, and the resulting mixture was stirred at 1000 rpm for 60 minutes and then cooled naturally to 25° C. to prepare samples. After 24 hours, the temperature of each of the thus obtained samples was adjusted to 25° C. in a water bath, and the type B viscosity was measured. The temperature of the water bath was then raised to 35° C. and kept for 1 hour, followed by measurement of the type B viscosity again. The thus obtained type B viscosities of samples (60 rpm) are shown in Table 2, and the type B viscosities (6 rpm) are shown in Table 4.

### Comparative Example 2

A thickening composition was prepared in the same manner as in Example 1 except that (A) 50 g of xanthan gum and (B) 50 g of locust bean gum were used and the component (C) was not used, and then samples were obtained. The type B viscosities (60 rpm) of these samples are shown in Table 2, and the type B viscosities (6 rpm) are shown in Table 4.

### Comparative Example 3

A thickening composition was prepared in the same manner as in Example 1 except that all three components of (A) 50 g of xanthan gum, (C) 10 g of guar gum and (B) 40 g of locust bean gum were added into AIBOI wide-mouthed bottle (250 ml) and mixed by manual shaking for 15 minutes, and then samples were obtained. The type B viscosities (60 rpm) of these samples are shown in Table 2, and the type B viscosities (6 rpm) are shown in Table 4.

### Comparative Example 4

A thickening composition was prepared in the same manner as in Example 2 except that all three components of (A) 50 g of xanthan gum, (C) 10 g of guar gum and (B) 40 g of locust bean gum were added into AIBOI wide-mouthed bottle (250 ml) and mixed by manual shaking for 15 minutes for preparation, and then samples were obtained. The type B viscosities (60 rpm) of these samples are shown in Table 2, and the type B viscosities (6 rpm) are shown in Table 4.

### Comparative Example 5

A thickening composition was prepared in the same manner as in Example 2 except that (A) 50 g of xanthan gum and (B) 50 g of locust bean gum were used and the component (C) was not used, and then samples were obtained. The type B viscosities (60 rpm) of these samples are shown in Table 2, and the type B viscosities (6 rpm) are shown in Table 4.

### Comparative Example 6

A thickening composition was prepared in the same manner as in Example 4 except that (A) 64 g of xanthan gum and (B) 16 g of locust bean gum were added into AIBOI wide-mouthed bottle (250 ml) and mixed by manual shaking for 5 minutes, followed by addition of (C) 20 g of guar gum into the resulting mixture and further mixture for 5 minutes, and then samples were obtained. Elastic modulus (Pa) and the slope of loss tangent (tan δ) at 10° C. of this sample were measured in the same manner as in Example 5. The results are shown in Table 6.

### Comparative Example 7

Into AIBOI wide-mouthed bottle (250 ml), (B) 20 g of locust bean gum and (A) 80 g of xanthan gum were added and mixed by manual shaking for 5 minutes to prepare a thickening composition, thereby obtaining the sample. This composition was adjusted to the concentration of 0.4% by mass so that the elastic modulus (40 Pa, 5° C.) is similar to that of Example 4 and 5, thereby obtaining the sample in the same manner as in Example 4. Elastic modulus (Pa) and the slope of loss tangent (tan δ) at 10° C. of this sample were measured in the same manner as in Example 5. The results are shown in Table 6.

### Comparative Example 8

A thickening composition was prepared in the same manner as in Example 4 except that all three components of (B) 16 g of locust bean gum, (C) 20 g of guar gum and (A) 64 g of xanthan gum were simultaneously added into AIBOI wide-mouthed bottle (250 ml) and mixed by manual shaking for 5 minutes, and then a sample was obtained. Elastic modulus (Pa) and the slope of loss tangent (tan δ) at 10° C. of this sample were measured in the same manner as in Example 4. The results are shown in Table 6.

### Comparative Example 9

Samples were obtained in the same manner as in Example 4 except that gelatin was used in place of the thickening composition and that the gelatin was prepared to the concentration of 5%. As physical property of the samples, the elastic modulus (Pa) at 10° C. and 20° C. were measured in the same manner as in Example 4. The results are shown in Table 7.

TABLE 1

| | | Example | | |
|---|---|---|---|---|
| | | 1 | 2 | 3 |
| Type B | 25° C. | 2790 | 1758 | 3200 |
| viscosity | 35° C. | 1240 | 931 | 1550 |

| | | | |
|---|---|---|---|
| Decrease ratio of the | 44 | 53 | 50 |
| viscosity (%) 35° C./25° C. | | | |

TABLE 2

| | | Comparative Example | | | | |
|---|---|---|---|---|---|---|
| | | 1 | 2 | 3 | 4 | 5 |
| Type B | 25° C. | 2500 | 2700 | 2640 | 2740 | 1384 |
| viscosity | 35° C. | 1630 | 2025 | 1730 | 1528 | 1250 |

| | | | | | |
|---|---|---|---|---|---|
| Decrease ratio of the | 65 | 75 | 66 | 55 | 90 |
| viscosity (%) | | | | | |
| 35° C./25° C. | | | | | |

TABLE 3

| | | Example | | |
|---|---|---|---|---|
| | | 1 | 2 | 3 |
| Type B | 25° C. | 18300 | 7580 | 23000 |
| viscosity | 35° C. | 9100 | 4440 | 9800 |

| | | | |
|---|---|---|---|
| Decrease ratio of the | 50 | 58 | 41 |
| viscosity (%) 35° C./25° C. | | | |

TABLE 4

| | | Comparative Example | | | | |
|---|---|---|---|---|---|---|
| | | 1 | 2 | 3 | 4 | 5 |
| Type B | 25° C. | 18300 | 20500 | 14900 | 17417 | 6680 |
| viscosity | 35° C. | 12400 | 15100 | 11100 | 11467 | 6680 |

| | | | | | |
|---|---|---|---|---|---|
| Decrease ratio of the | 68 | 73 | 74 | 65 | 100 |
| viscosity (%) | | | | | |
| 35° C./25° C. | | | | | |

As seen from these tables, when the thickening composition of the present invention is contained in a low-viscosity substance, the viscosity can be high and can be lowered at a specific temperature irrespective of the environment. Since the thickening composition of the present invention has such a physical property, it is assumed that when the thickening composition is applied to foods, medical supplies or industrial products, products having improved physical properties such as shape and safety with temperature.

### Viscoelasticity Characteristics

Storage shear modulus (E), loss shear modulus (E″) and the ratio E″/E′ (tan δ) of the samples obtained in Example 2 and Comparative Example 2 were determined The results are shown in Table 5. Measurement conditions are as follows:
Measuring device: Dynamic viscoelasticity measuring device
Measurement Conditions: Amplitude: designated value, displacement A200.00
   Temperature: change continuously
   Frequency: designated value 4.00

TABLE 5

| | | | | | Comparative | | | | Comparative | |
|---|---|---|---|---|---|---|---|---|---|---|
| Time | Frequency | Amplitude | Amplitude | Temperature | Example 2 | | Example 2 | | Example 2 | Example 2 |
| (min) | (Hz) | (μm) | (g) | (° C.) | E′ (kPa) | E″ (kPa) | E′ (kPa) | E″ (kPa) | tan δ | tan δ |
| 16.1798 | 4.0527 | 186.4636 | 9.7756 | 20.3517 | 3.91 | 0.41 | 4.67 | 1.61 | 0.11 | 0.34 |
| 17.1753 | 4.0527 | 186.4902 | 9.7073 | 21.0438 | 4.07 | 0.45 | 4.63 | 1.62 | 0.11 | 0.35 |
| 18.1768 | 4.0527 | 186.5519 | 9.5919 | 21.9014 | 3.90 | 0.49 | 4.54 | 1.70 | 0.13 | 0.38 |
| 19.1781 | 4.0527 | 186.5902 | 9.4626 | 22.707 | 3.82 | 0.69 | 4.48 | 1.67 | 0.18 | 0.37 |
| 20.1792 | 4.0678 | 186.6197 | 9.4259 | 23.4185 | 4.02 | 0.67 | 4.43 | 1.73 | 0.17 | 0.39 |
| 21.1761 | 4.0664 | 186.7224 | 9.157 | 23.8856 | 3.68 | 0.50 | 4.28 | 1.75 | 0.14 | 0.41 |
| 22.1757 | 4.0706 | 186.7858 | 9.0946 | 24.8002 | 3.63 | 0.48 | 4.18 | 1.89 | 0.13 | 0.45 |
| 23.1775 | 4.0541 | 186.8223 | 8.8872 | 26.0185 | 3.69 | 0.49 | 4.12 | 1.75 | 0.13 | 0.43 |
| 24.1764 | 4.0637 | 186.8939 | 8.7429 | 26.7151 | 3.74 | 0.75 | 4.02 | 1.82 | 0.20 | 0.45 |
| 25.1787 | 4.0733 | 186.953 | 8.5771 | 27.4306 | 3.69 | 0.59 | 3.93 | 1.81 | 0.16 | 0.46 |
| 26.1785 | 4.0527 | 187.0534 | 8.3662 | 28.3859 | 3.61 | 0.43 | 3.77 | 1.88 | 0.12 | 0.50 |
| 27.1775 | 4.0541 | 187.0858 | 8.3354 | 29.3763 | 3.61 | 0.43 | 3.72 | 1.94 | 0.12 | 0.52 |
| 28.1772 | 4.0527 | 187.1506 | 8.1283 | 30.247 | 3.23 | 0.39 | 3.63 | 1.90 | 0.12 | 0.52 |
| 29.1775 | 4.0527 | 187.262 | 7.8905 | 30.985 | 3.11 | 0.54 | 3.46 | 1.95 | 0.17 | 0.56 |
| 30.1781 | 4.0582 | 187.285 | 7.8023 | 32.1657 | 3.32 | 0.73 | 3.42 | 1.92 | 0.22 | 0.56 |
| 31.1796 | 4.0527 | 187.3957 | 7.5955 | 32.9938 | 3.10 | 0.73 | 3.26 | 2.00 | 0.23 | 0.61 |
| 32.1805 | 4.0719 | 187.4577 | 7.9008 | 33.7283 | 3.08 | 0.59 | 3.16 | 2.41 | 0.19 | 0.76 |
| 33.1771 | 4.0664 | 187.5405 | 7.9782 | 34.8126 | 3.01 | 0.56 | 3.03 | 2.62 | 0.18 | 0.86 |
| 34.1796 | 4.0541 | 187.7349 | 7.4862 | 35.747 | 2.68 | 0.66 | 2.74 | 2.57 | 0.25 | 0.94 |
| 35.1765 | 4.065 | 187.7434 | 7.42 | 36.4342 | 2.90 | 0.88 | 2.73 | 2.53 | 0.30 | 0.93 |
| 36.1799 | 4.0513 | 187.9311 | 6.776 | 37.4141 | 2.34 | 0.62 | 2.45 | 2.66 | 0.26 | 1.08 |
| 37.1775 | 4.0527 | 187.9891 | 6.6844 | 38.2887 | 2.55 | 0.40 | 2.36 | 2.58 | 0.16 | 1.09 |
| 38.1809 | 4.0719 | 188.1013 | 7.0203 | 38.9806 | 2.18 | 0.30 | 2.19 | 2.75 | 0.14 | 1.26 |
| 39.1786 | 4.0527 | 188.2997 | 6.9581 | 39.8401 | 2.22 | 0.56 | 1.89 | 2.92 | 0.25 | 1.55 |
| 40.1771 | 4.0527 | 188.3825 | 6.484 | 40.7739 | 2.08 | 0.35 | 1.77 | 2.72 | 0.17 | 1.54 |

As seen from this table, tans of the samples in Comparative Example 2 does not change largely at each temperature range. Thus, it is thought that the samples in Comparative Example 2 have a constant viscosity even in an environment having a specific salt concentration. On the other hand, it can be seen that the viscosity of the sample in Example 2 whose tans value is dramatically increased from around 30° C., can be controlled at a specific temperature.

TABLE 6

| | Example | | Comparative Example | | |
|---|---|---|---|---|---|
| | 4 | 5 | 6 | 7 | 8 |
| Elastic | 32.8 | 34.7 | 33.4 | 34.8 | 32.8 |
| modulus | | | | | |
| (Pa, 10° C.) | | | | | |
| Loss tangent | slope | slope | slope | slope | slope |
| (tan δ) | 1.2539 | 1.1129 | 1.0411 | 1.0882 | 1.0867 |

As seen from this table, when the thickening composition of the present invention is contained in a low-viscosity substance, the viscoelasticity can be high and changes in viscoelasticity at a specific temperature can be securely developed by mixing component (C) and another component. Since the thickening composition of the present invention has such a physical property, it is assumed that when the thickening composition is applied to foods, medical supplies or industrial products, products having improved physical properties such as shape, safety and in-mouth meltability with temperature.

TABLE 7

| | | Comparative |
|---|---|---|
| | Example 4 | Example 9 |
| Loadings (%) | 0.5 | 5 |
| Elastic modulus | 32.8 | 31.3 |
| (Pa, 10° C.) | | |
| Elastic modulus | 19.47 | 0.063 |
| (Pa, 20° C.) | | |

As seen from this table, using the method of producing the thickening composition of the present invention, loadings of the thickening composition can be 1/10 amount of gelatin, and in-mouth meltability more close to gelatin can be developed. Since the thickening composition of the present invention has such a physical property, it is assumed that when the thickening composition is applied to foods, medical supplies or industrial products as alternative material of gelatin, products having improved physical properties such as shape, safety and in-mouth meltability with temperature.

### INDUSTRIAL APPLICABILITY

The highly thickening composition of the present invention is useful as an additive for improving the viscosity of low-viscosity substance in food or cosmetic field and for changing (controlling) the viscosity at a specific temperature.

1. A highly thickening composition produced by mixing one of either (A) xanthan gum or (B) locust bean gum with (C) guar gum and then mixing the component (A) or the component (B) to the resultant mixture, wherein the ratio of the total amount of the components (A) and (B) to the amount of the component (C) is 95:5 to 70:30 by mass and the component (A) is contained in a larger amount than the component (B).

2. The highly thickening composition according to the claim 1, wherein the component (B) and the component (C) are mixed and then the component (A) is mixed with the resultant mixture.

3. A method of producing a highly thickening composition, the method comprising mixing one of either (A) xanthan gum or (B) locust bean gum with (C) guar gum so that the compounding ratio of the component (C) ranges from 5 to 30% by mass of the overall highly thickening composition and then mixing the component (A) or the component (B) to the resultant mixture, wherein the compounding ratio of the component (A) is more than that of the component (B).

4. A low-viscosity substance, wherein the highly thickening composition according to the claim 1 is added.

5. A method of controlling viscosity of a low-viscosity substance, wherein the salt concentration is adjusted to 0.01% or more and the temperature is maintained in the range between 25° C. and 35° C. for controlling the viscosity of the low-viscosity substance according to the claim 4.
